(19) United States
(12) Patent Application Publication
(10) Pub. No.: US 2023/0265774 A1
(43) Pub. Date: Aug. 24, 2023

(54) Apparatus For Mixing An Additive With A Gas Flow

(71) Applicant: Friedrich Boysen GmbH & Co. KG, Altensteig (DE)

(72) Inventors: Stefan SAUER, Wildberg (DE); Igor ROGOWSKI, Nagold (DE); Robert ANSELM, Nagold (DE); Marco FRIESE, Pfalzgrafenweiler (DE)

(21) Appl. No.: 18/112,538

(22) Filed: Feb. 22, 2023

(30) Foreign Application Priority Data
Feb. 23, 2022 (DE) 10 2022 104 314.2

(51) Int. Cl. F01N 3/20; F01N 3/28; B01F 23/213; B01F 23/20; B01F 25/23; B01F 35/71; B01D 53/94

(52) U.S. Cl. CPC F01N 3/208; F01N 3/2892; B01F 23/2132; B01F 23/29; B01F 25/23; B01F 35/714; B01F 35/7179; B01D 53/9418; F01N 2610/02; F01N 2610/1453; B01F 2025/918

(57) ABSTRACT

The present invention relates to an apparatus for mixing an additive with a gas flow, in particular for an exhaust gas system of a vehicle having an internal combustion engine, that comprises a mixing chamber which can be flowed through by at least a portion of the gas flow, said mixing chamber having at least one inlet opening through which a main inlet flow of the gas flow flows into the mixing chamber on operation of the apparatus, having at least one metering opening and having at least one outlet opening. The apparatus further comprises a metering device by means of which an additive flow of the additive can be introduced into the mixing chamber through the metering opening, wherein the inlet opening and the metering opening are arranged and formed such that the main inlet flow and the additive flow in substantially opposite directions into the mixing chamber so that the main inlet flow and the additive flow impact one another.

The invention relates to an apparatus for mixing an additive with a gas flow, in particular for an exhaust gas system of a vehicle having an internal combustion engine.

Exhaust gas aftertreatment systems, for example SCR systems (selective catalytic reduction systems), can be used to reduce nitrogen oxides in exhaust gases from motor vehicles having internal combustion engines. SCR in this respect refers to a chemical reaction, namely a selective catalytic reduction in which the nitrogen oxides such as nitrogen monoxide and nitrogen dioxide are preferably reduced, i.e. converted into harmless substances. For the chemical reaction, ammonia or a urea solution (AdBlue), from which the ammonia is generated by thermolysis, has to be mixed to the exhaust gas as an additive. The exhaust gas supplied with the additive is then fed to a catalytic converter in which the catalytic reduction takes place.

One of the challenges in the field of SCR systems, and specifically the SCR systems in the commercial vehicle sector, is a deposit-free evaporation and a good mixing of suitable AdBlue metering quantities with the exhaust gas in different exhaust gas mass flows and at different exhaust gas temperatures.

The properties of the evaporation depend largely on the hot surfaces available, the so-called evaporator surfaces, for the evaporation of the additive. Large surfaces are to be preferred for a good evaporation, but a large installation space volume is required for this purpose. Furthermore, it can be difficult to ensure a uniform AdBlue wetting with a discrete spray cone for such large-area designs.

Known solution approaches attempt, for example, to apply the urea solution in the direction of flow of the exhaust gas together with the exhaust gas by spray drifting onto a cylindrical jacket surface of a pipe arranged in the exhaust train. However, in the case of small mass flows of the exhaust gas, this can result in the urea solution injected into the pipe spraying through the pipe unimpeded and in the exhaust gas direction and thus not evaporating and mixing quickly and therefore not being able to be fully utilized for the chemical reaction with the exhaust gas.

The mixing of the evaporated AdBlue with the exhaust gas is also unsatisfactory in many cases. However, a mixture that is as homogeneous as possible is an important prerequisite for an optimum exhaust gas aftertreatment.

In addition to exhaust gas technology, there is also a need in other areas for an efficient mixing of an additive with a gas flow.

It is an object of the invention to provide an apparatus that has improved properties in this respect. In particular, an additive, e.g. a urea solution for exhaust gas aftertreatment, should be able to be applied to as large an evaporator surface as possible and a high evaporation and a mixing that is as homogeneous as possible should be able to be achieved even with a small exhaust gas flow.

These objects are satisfied by an apparatus having the features of claim 1.

In accordance with a first aspect of the invention, an apparatus for mixing an additive with a gas flow, in particular for an exhaust gas system of a vehicle having an internal combustion engine, has a mixing chamber and a metering device. The mixing chamber can be flowed through by at least a portion of the gas flow and comprises at least one inlet opening through which a main inlet flow of the gas flow flows into the mixing chamber on operation of the apparatus. Furthermore, the mixing chamber comprises at least one metering opening and at least one outlet opening. By means of the metering device, an additive flow of the additive can be introduced into the mixing chamber through the metering opening, in particular as a stream of fine liquid droplets. The inlet opening and the metering opening are arranged and formed such that the main inlet flow and the additive flow flow in substantially opposite directions into the mixing chamber so that the main inlet flow and the additive flow impact one another. The apparatus is thus designed such that the two material flows—figuratively speaking—meet in an impact flow.

Due to the impacting of the main inlet flow and the additive flow, the two flows are mixed with one another such that the gaseous main inlet flow forms a mixture together with the liquid additive flow. In this connection, the impacting of the main inlet flow with the additive flow does not necessarily have to mean that one of the two flows is deflected from its direction of flow, in particular if the ratio of the liquid additive flow to the gaseous main inlet flow is very small, for example, 1:500. The direct impacting of the main inlet flow with the additive flow can lead to a splitting, a spreading, or a division of the additive flow so that the additive flow is distributed in the interior of the mixing chamber. A high relative inflow speed of the main inlet flow through the inlet opening into the mixing chamber can in particular favor an advantageous distribution of the additive flow in the mixing chamber. The distribution of the additive flow in the mixing chamber can cause the additive flow to impact hot evaporator surfaces, which makes the evaporation of the additive more efficient, in particular if these surfaces are flowed onto as perpendicular as possible in this respect. The additive flow or portions thereof may or may not impact at different positions of the evaporator surfaces depending on the properties of the mass flow of the main inlet flow (e.g. depending on the inflow speed of the main inlet flow into the mixing chamber), e.g. at a relatively high inflow speed, more likely at an upper wall section in the vicinity of the metering opening and, at a relatively low inflow speed, more likely at a lower wall section in the vicinity of the inlet opening. Furthermore, due to the arrangement and design of the inlet opening and the metering opening and the associated introduction of the additive flow and the main inlet flow in opposite directions into the mixing chamber, a good mixing with the additive flow can be achieved even with a small flow of the main inlet flow, for example with a small load of the internal combustion engine, since only a displacement of the impact flow structure takes place without the basic functionality of the apparatus suffering. Due to the direct impacting of the main inlet flow with the additive flow, the dwell time of the additive distributed after the impact in the mixing chamber can furthermore be increased, which in turn leads to a better evaporation of the additive.

Provision can be made to carry out the metering in of the additive in dependence on at least one characteristic property of the gas flow or of the main inlet flow. A characteristic property is, for example, a mass flow per unit of time. The adaptation of the metering in to the respective present gas flow or main inlet flow inter alia prevents an oversaturation of the gas flow with the additive and/or ensures a suitable formation of the impact flow to ensure that the mixing of the gas with the additive flow takes place in a suitable region of the mixing chamber. For example, it can thereby be prevented that the additive enters the region of the inlet opening or even passes through it when the main inlet flow is comparatively weak. Conversely, the additive flow can be amplified when the main inlet flow is strong.

The internal combustion engine can be configured as a combustion engine, in particular as a diesel engine. During operation of the internal combustion engine, exhaust gases arise that are conducted to the outside as a gas flow via an exhaust gas system connected to the internal combustion engine. The exhaust gas system can comprise an apparatus described herein.

The additive can be a liquid reductant such as a urea solution that evaporates through the exhaust gas and that provides the ammonia required for the exhaust gas purification by means of thermolysis or hydrolysis. The liquid reductant can be stored in a tank and can be fed to the metering device by means of a feed line.

The metering device can be configured to atomize the additive, for example with the aid of an injection nozzle, i.e. to divide the additive into small droplets and to introduce them in the form of a spray cone into the mixing chamber of the apparatus.

The mixing chamber can be configured as a substantially closed space, for example, a chamber bounded by metal sheets. In the interior of the mixing chamber, flows can mix or inflowing gas can combine with injected liquids, for example, urea. At least a portion of the gas flow, for example of the exhaust gas, can flow into the mixing chamber through the inlet opening. An additive, for example a urea solution, can be introduced, in particular injected, into the mixing chamber through the metering opening. For the discharging or flowing out of the mixture generated into the mixing chamber on operation of the apparatus, the mixing chamber can comprise at least one outlet opening. The outlet opening can be connected to the exhaust gas system of a vehicle.

Further embodiments of the present invention are set forth in the following as well as in the dependent claims and in the enclosed drawings.

In some embodiments, the inlet opening and the metering opening are arranged at mutually oppositely disposed wall sections of the mixing chamber. The mutually oppositely disposed wall sections can bound the mixing chamber and can, for example, be formed from metal sheets. Due to this spatial arrangement of the inlet opening and the metering opening, the impacting of the main inlet flow and the additive flow in the mixing chamber, i.e. an impact flow, is produced in a simple manner.

The inlet opening can be designed as substantially round or rectangular. Other designs of the inlet opening, for example oval or polygonal, are likewise possible.

A center axis of the main inlet flow and a center axis of the additive flow can be arranged substantially coaxially. The center axis of the main inlet flow can extend starting from the inlet opening in the direction of the metering opening, whereas the center axis of the additive flow can extend starting from the metering opening in the direction of the main inlet opening. The center axis of the main inlet flow and the center axis of the additive flow can be substantially coaxial or can extend with a parallel offset from one another. Accordingly, the directions of flow of the main inlet flow and the additive flow can also be substantially coaxially aligned. Since the additive flow can be introducible into the mixing chamber in the form of a spray cone in the opposite direction to the main inlet flow, the main inlet flow and portions of the additive flow can also meet in the mixing chamber at an angle of less than 180°.

In another embodiment, the one center axis of the additive flow can lie in a center plane of the main inlet flow. The center plane of the main inlet flow is in particular arranged approximately centrally with respect to the inlet opening.

In some embodiments, the at least one outlet opening of the mixing chamber can be arranged at a wall section that, viewed in the direction of the center axis of the main inlet flow or in the direction of the center axis of the additive flow, is disposed between the metering opening and the inlet opening, for example, at a side wall of the chamber. The outlet opening can be substantially circular, oval or polygonal and can be dimensioned such that, for example, a certain average dwell time of the additive in the mixing chamber is ensured. The wall section that is arranged between the metering opening and the inlet opening can be formed from metal sheets and can be connected (e.g. in one piece) to the mutually oppositely disposed wall sections of the mixing chamber.

The outlet opening of the mixing chamber can form a gas outlet of the apparatus so that a gas flow can flow from the mixing chamber through the outlet opening out of the apparatus. The apparatus, for example, does not have a further outlet opening so that gas flowing into the apparatus can only flow out via the one outlet opening. A gas flow that flows from the mixing chamber through the outlet opening of the apparatus can have a direction of flow that is oriented substantially perpendicular to the center axis of the main inlet flow or to the center axis of the additive flow.

In some embodiments, the mixing chamber can be circular, toroidal or rectangular in a plane in parallel with the center axis of the main inlet flow and/or of the additive flow. The cross-section of the mixing chamber in the plane perpendicular to the center axis of the main inlet flow and the additive flow can likewise be selected in accordance with requirements. In a substantially spherical embodiment of the apparatus, the cross-section of the mixing chamber in this plane can be substantially circular; in a substantially cylindrical embodiment, the cross-section of the mixing chamber in this plane can be substantially rectangular. Other cross-sections of the mixing chamber, such as oval cross-sections, are likewise possible in other embodiments.

In some embodiments, at least one wall section of the mixing chamber having the inlet opening can be designed as at least sectionally curved; the at least one wall section adjacent to the inlet opening can in particular be designed in U shape. The U-shaped wall section can have asymmetrical legs that also cannot extend in parallel with one another. Furthermore, the two legs of the U-shaped wall section can have different lengths. In a U-shaped design of the wall section adjacent to the inlet opening, an indentation projecting into the interior of the mixing body can be formed that supports the inlet opening. The indentation can contribute to a better swirl or to a better swirling of a gas mixture in the mixing chamber.

The (lateral) wall sections disposed between the inlet opening and the metering opening can be at least sectionally curved (e.g. “bulgy”), in particular viewed in a plane that is arranged in parallel with the main inlet flow and/or the additive flow or that includes their center axis. For example, the mixing chamber has a toroidal, “spherical” or cylindrical basic shape. Due to this design, as large as possible an area which a gas-additive mixture can impact in the interior of the mixing chamber can be provided. As large as possible an area facilitates a better evaporation of the gas-additive mixture. In addition, the lateral wall sections can assist a swirl formation in the flow pattern of the gas mixture in the mixing chamber.

In some embodiments, the mixing chamber can have at least one secondary opening through which a secondary inlet flow of the gas flow flows into the mixing chamber on operation of the apparatus. The at least one secondary opening can be arranged at a wall section in the region of or adjacent to the inlet opening of the mixing chamber or at a lateral wall section of the mixing chamber. Due to the at least one secondary opening, a portion of the gas flow can flow into the mixing chamber in addition to the inlet opening. The secondary inlet flow can counteract a pressure drop reduction in the mixing chamber.

The at least one secondary opening can be associated with at least one flow-conducting section, in particular a planar and/or a curved wall section, that can be designed and arranged such that the secondary inlet flow is deflected when entering into the mixing chamber. The at least one flow-conducting section of the secondary opening can be formed from a wall section of the mixing chamber. For example, a part of the wall section can be punched out and can be bent inwardly, i.e. into the mixing chamber, to deflect the gas flow in a suitable form that flows into the mixing chamber through the secondary opening. This can further assist a swirl formation in the interior of the mixing chamber and a mixing of the exhaust gas with the additive can be accelerated. A plurality of secondary openings, each having at least one flow-conducting section, can be arranged at the mixing chamber.

In some embodiments, the metering device can be associated with a screening device that has at least one flushing opening through which a portion of the gas flow can pass as a flushing flow into a metering-in region of the metering device; the flushing opening can in particular be associated with a flow-conducting unit that, for example, effects or at least assists a swirl formation of the flushing flow. As already mentioned, the metering device can comprise an injection nozzle. The screening device can protect the injection nozzle from a direct inflow and can simultaneously ensure through the flushing openings that at least a portion of the gas flow flowing into the apparatus flows through the flushing openings into the screening device, and thus to the metering device, and in this way cleans the injection nozzle or prevents the formation of deposits at the injection nozzle.

In some embodiments, the mixing chamber can be at least sectionally surrounded by a housing that has a gas inlet for the gas flow, wherein the interior of the mixing chamber is in communication with the interior of the housing at least via the inlet opening. The housing can completely or only partly surround the mixing chamber. The mixing chamber can be arranged in the housing such that the gas flow that flows through the gas inlet into the housing cannot flow directly into the mixing chamber. In other words, the inlet opening and the metering opening of the mixing chamber can be arranged with respect to the housing such that the directions of flow of the main inlet flow and the additive flow are oriented differently from a direction of flow of the gas flow flowing into the housing. For example, the outlet opening of the mixing chamber and the gas inlet enable an axial flowing of the gas out of and into the apparatus. In some embodiments, the outlet opening can also be arranged at an angle, for example by 90°, to the gas inlet.

In some embodiments, the outlet opening of the mixing chamber can be in communication with a channel through which the gas flow exiting from the mixing chamber is discharged from the housing. For this purpose, openings can be arranged in the lateral wall sections of the mixing chamber, through which openings the gas flow can be conducted from the mixing chamber into the channel.

In such an embodiment, the channel can at least sectionally surround, in particular completely surround, the mixing chamber at an outer side in a region between the metering opening and the inlet opening in a peripheral direction. This embodiment enables an optimized arrangement of the outlet opening for the respective application, i.e. the outlet opening can be arranged at any desired point at the channel. Thus, marginal conditions related to the installation space can be taken into account and the apparatus can be flexibly adapted.

It is conceivable that the metering device is supported by the housing and is arranged spaced apart from the inlet opening. The metering device can be fastened to the housing of the apparatus via a holding apparatus. The holding apparatus can seal the housing in a gas-tight manner so that no gas flow can flow through the holding apparatus out of the housing.

In some embodiments, a gap can be at least sectionally formed between the mixing chamber and the housing and, during operation, is flowed through by at least a portion of the gas flow entering the housing through the gas inlet so that the mixing chamber is at least sectionally heated from the outside. This improves the evaporation of droplets of the additive impacting wall sections, which is in particular advantageous on a cold start of an internal combustion engine that is connected to an exhaust gas system comprising the apparatus in accordance with the invention. If the apparatus—as described by way of example above—has a channel that is connected to the at least one outlet opening of the mixing chamber, the channel can be arranged in the gap between the mixing chamber and the housing. This enables a flowing around of the channel by the gas flow that flows into the housing and that thereby heats the channel from the outside. The channel can also be heated from the inside by the gas flow flowing out of the mixing chamber. Thus, any evaporation of the gas-additive mixture that may not be complete in the interior of the mixing chamber can also still take place in the channel or at wall surfaces of the channel before the mixture exits through the outlet opening.

In some embodiments, at least one gas-conducting component can be arranged in the gap or in the direction of flow upstream of the gap in order to influence the gas flow in the gap and/or into the gap. The gas-conducting component can have openings through which the gas flow can flow into the gap. However, it is also possible that the gas-conducting component has no openings at certain points so that the gap is blocked in these regions. The openings can be designed such that the gas flow flowing into the gap through the openings is slowed down, split and/or deflected. For example, a portion of the gas flow flowing into the gap can be deflected by the gas-conducting component as the main inlet flow in the direction of the inlet opening of the mixing chamber, while another portion of the gas flow is deflected in the direction of the metering opening of the mixing chamber. Due to the spatial arrangement of the inlet opening of the mixing chamber and/or due to a suitable design of the gas-conducting component, a direct flowing onto the inlet opening can be prevented if required.

The metering opening can be arranged and designed such that a portion of the gas flow in the housing flows as a backflow together with the additive flow through the metering opening into the mixing chamber. A portion of the gas flow that is deflected by the gas-conducting component in the direction of the metering device and that flows into the housing or into the gap can form the backflow. The gaseous backflow can assist the flowing of the additive flow into the mixing chamber and can produce a stagnation flow with the main inlet flow. Due to the impacting of the main inlet flow with the backflow, the flows (and thus at least a portion of the additive flow) are deflected such that the direction of flow of the main inlet flow and the direction of flow of the backflow are urged outwardly in a radial direction after the impacting, idealized substantially perpendicular to the directions of flow of the gas flows flowing into the mixing chamber. On the one hand, the direct impacting of the main inlet flow with the backflow and the additive flow can cause a swirling of the main inlet flow with the additive flow and the backflow, whereby a better mixing of the two gas flows (main inlet flow and backflow) with the liquid additive flow is achieved. On the other hand, the outwardly urged flows can impact hot evaporator surfaces, which makes the evaporation of the additive more efficient, in particular if these areas are flowed onto as perpendicular as possible in this respect.

In some embodiments, a flow-conducting device can be provided that is configured to influence the backflow prior to the entry into the metering opening. The flow-conducting device can, for example, be configured as a perforated metal sheet and/or can comprise guide surfaces. Due to the design of the flow-conducting device, the portion of the gas flow that flows into the mixing chamber and that forms the backflow can be determined compared to the portion of the gas flow that flows into the mixing chamber and that forms the main inlet flow. The flow-conducting device can enable a swirl formation of the gas flow that flows through the flow-conducting device.

The flow-conducting device can comprise a separate component and/or it can be formed by at least one component that—if provided—is formed at the screening device and/or at the mixing chamber, in particular in the form of a collar formed at—if provided—the screening device and/or at the mixing chamber. The flow-conducting device can bound the space in which the metering device is arranged.

The apparatus is preferably designed such that, during operation, the main inlet flow portion of the gas flow is greater than the portion of the backflow and/or the portion of the backflow is greater than the portion of the gaseous flushing flow, wherein the main inlet flow makes up 70% to 30%, preferably 60% to 40%, in particular 55% to 45%, of the gas flow, and/or the backflow makes up 60% to 30%, preferably 50% to 35%, in particular 45% to 40%, of the gas flow, and/or the flushing flow makes up 20% to 1%, preferably 15% to 5%, in particular 12% to 8%, of the gas flow. A division of the gas flow has proved to be advantageous in which a large portion, i.e. more than 50%, of the gas flow flowing into the housing flows into the mixing chamber as the main inlet flow. A variety of factors and design measures can contribute to the division of the gas flow flowing into the housing between the various part flows, in particular the main inlet flow, the backflow and the flushing flow. For example, the size and the arrangement of the openings or guide elements or guide surfaces of the gas-conducting component or of the flow-conducting devices can influence both the distribution of the inflowing gas flow and the counter-pressure generated by the apparatus. The same inter alia also applies to the dimensioning of the gap and the geometric design of the mixing chamber. Similarly, the division can be dependent on a flow rate or a gas pressure of the gas flow flowing into the housing of the apparatus. On a use of the apparatus in an exhaust gas system, the gas pressure can be a function of the load state of the corresponding internal combustion engine.

A possibly present secondary inlet flow should also, as a rule, be smaller than the main inlet flow. However, the secondary inlet flow can be greater than, equal to, or less than the portion of the backflow of the gas flow.

In some embodiments, the apparatus can further comprise at least one further metering device by means of which a further additive flow of the additive can be introduced into the mixing chamber through the metering opening of the mixing chamber or through a further metering opening of the mixing chamber. The inlet opening and the metering opening or the further metering opening can be arranged and formed such that the main inlet flow and at least one of the additive flows (preferably both) flow in substantially opposite directions into the mixing chamber so that the main inlet flow and the additive flow impact one another.

The present invention furthermore relates to an exhaust gas system that has an apparatus in accordance with at least one of the embodiments described above.

The invention also relates to a vehicle having an internal combustion engine that is connected to an exhaust gas system of the kind described above.

The invention will be described in the following only by way of example with reference to embodiments and to the drawings. There are shown:

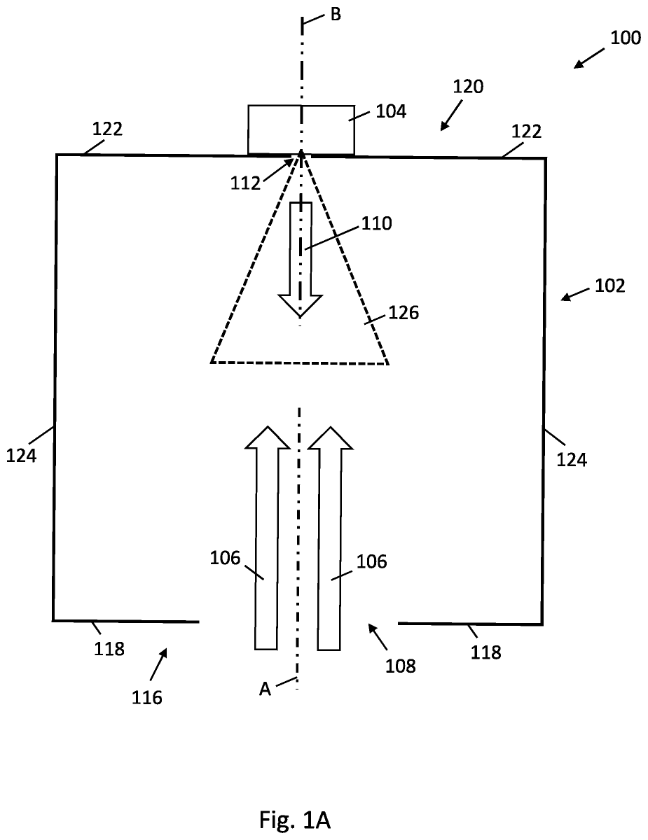

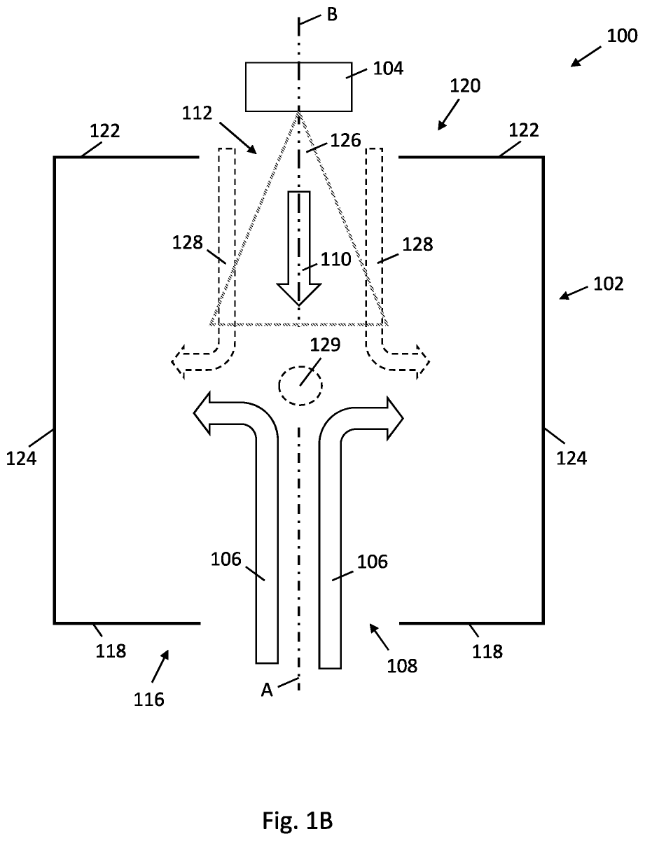

FIG. 1A shows a schematic representation of an embodiment of the apparatus in accordance with the invention;

FIG. 1B shows a schematic representation of a further embodiment of the apparatus in accordance with the invention;

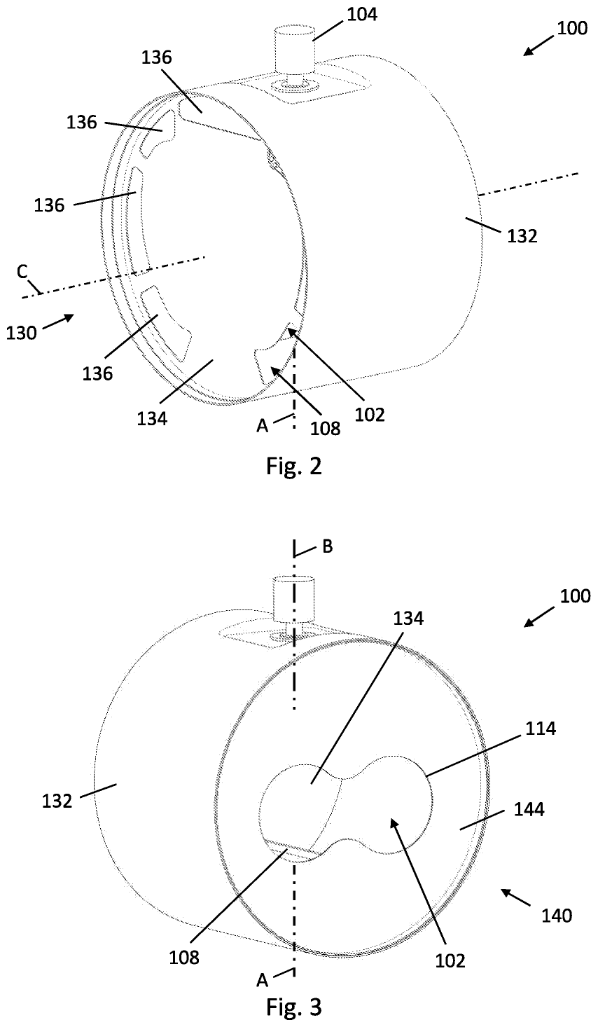

FIG. 2 shows a perspective representation of an inlet side of a cylindrical embodiment of the apparatus in accordance with the invention;

FIG. 3 shows a perspective representation of an outlet side of the embodiment of FIG. 2;

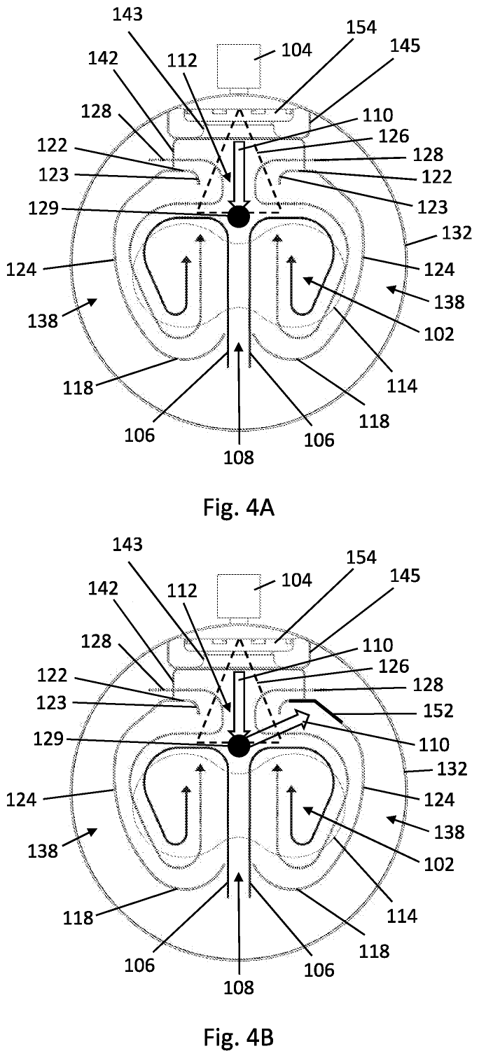

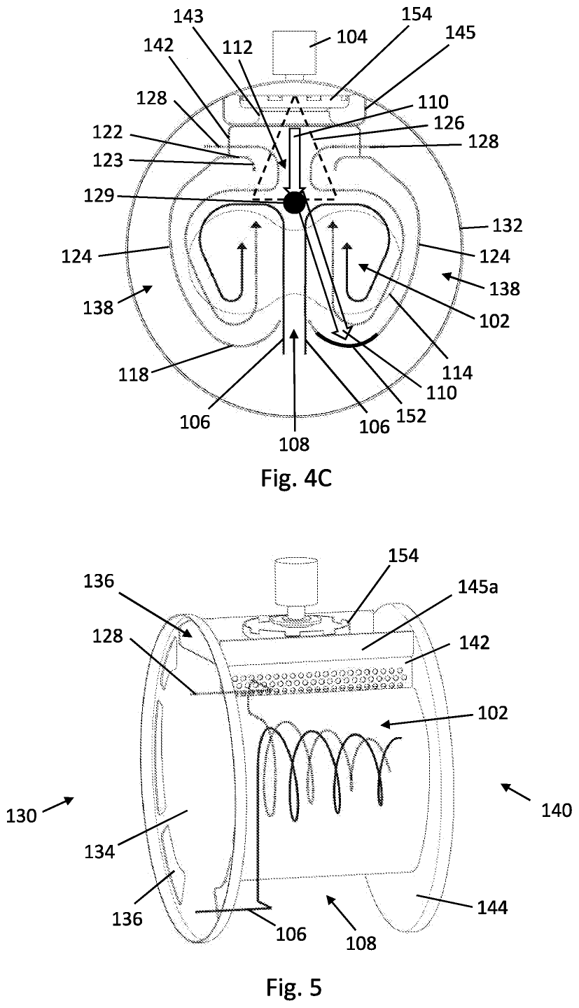

FIG. 4A shows a sectional representation of the embodiment of FIG. 2;

FIG. 4B shows a schematic representation of the distribution of the additive flow at a relatively high inflow speed of the main inlet flow of the embodiment of FIG. 2;

FIG. 4C shows a schematic representation of the distribution of the additive flow at a relatively low inflow speed of the main inlet flow of the embodiment of FIG. 2;

FIG. 5 shows a perspective representation of the embodiment of FIG. 2 without a housing;

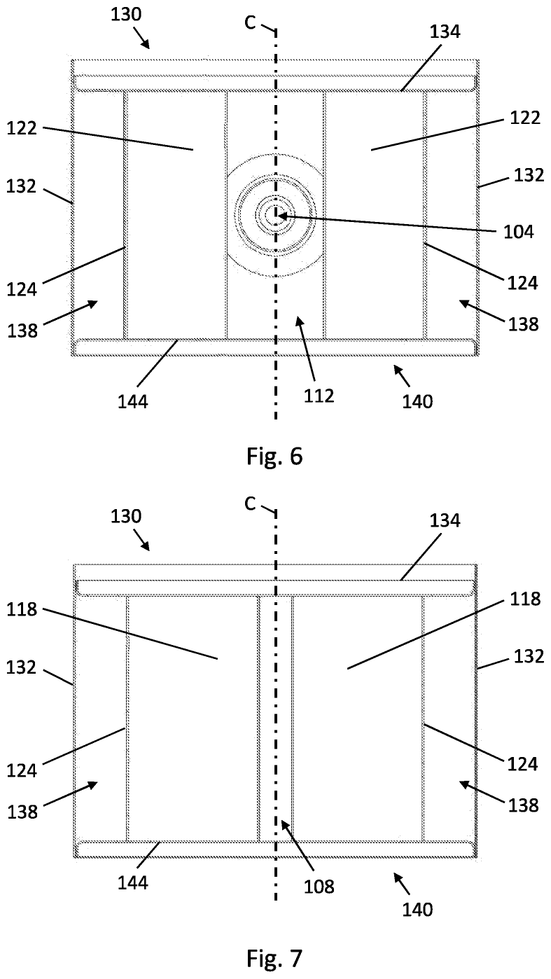

FIGS. 6 and 7 show different sections of the embodiment of FIG. 2;

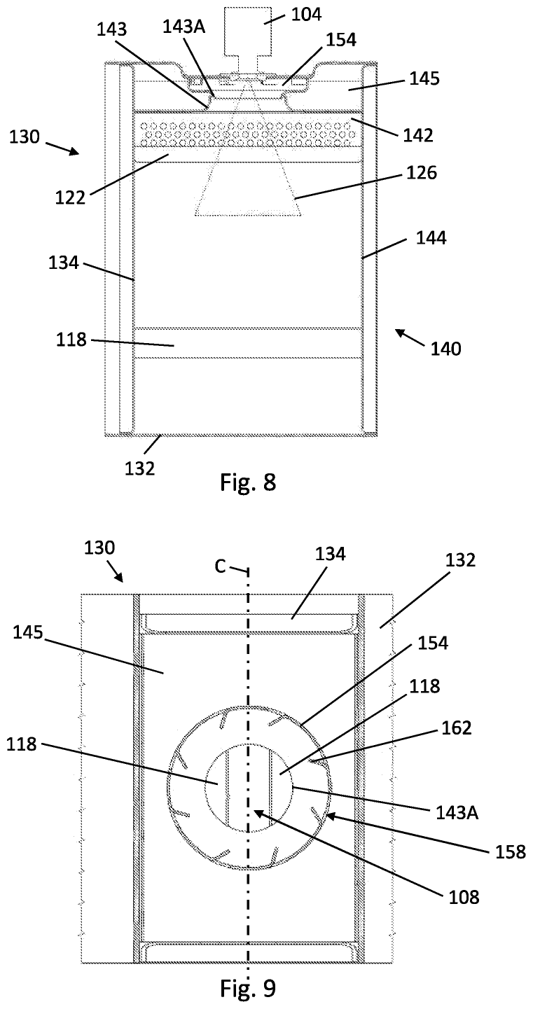

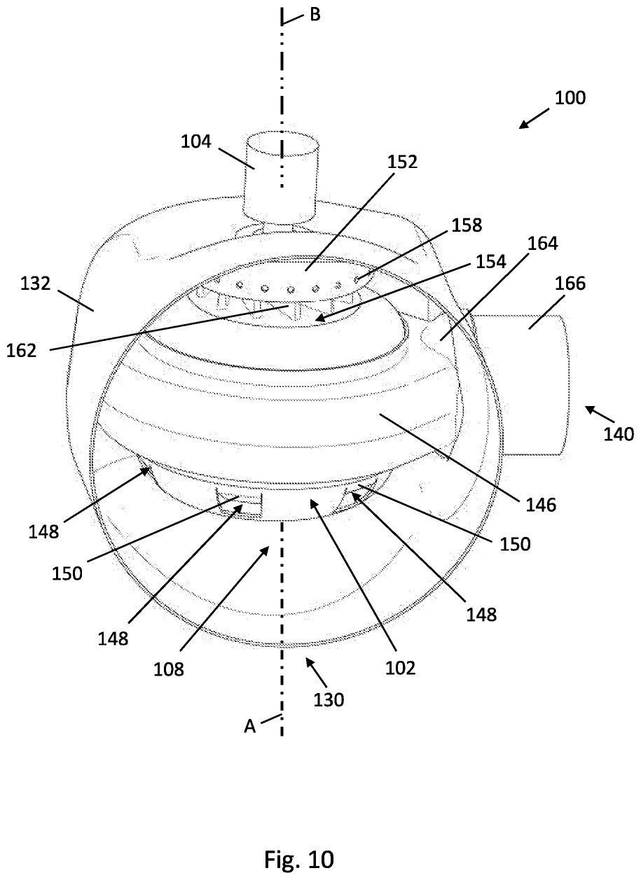

FIGS. 8 and 9 show different sections of a slightly modified embodiment of FIG. 2;

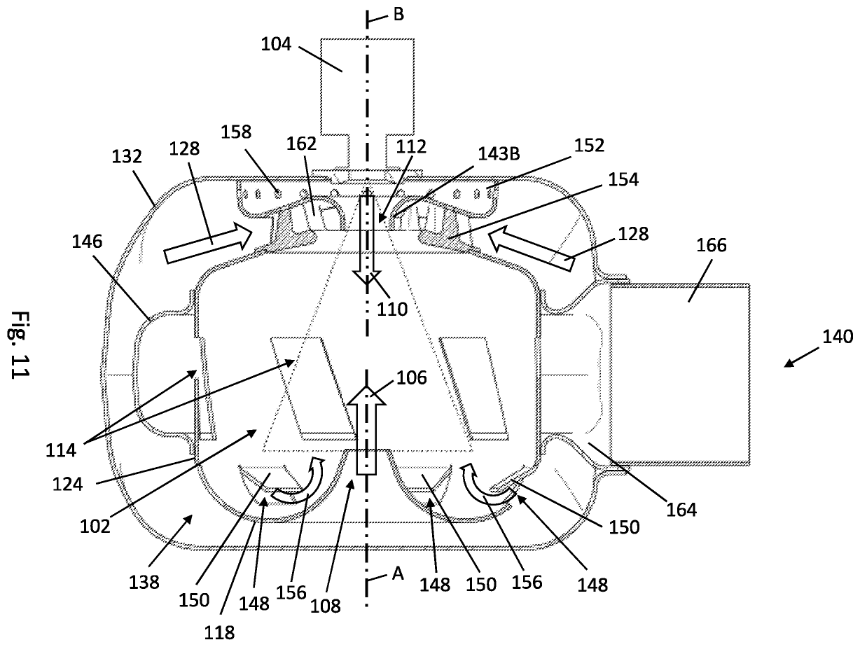

FIG. 10 shows a perspective representation of an inlet side of a spherical embodiment of an apparatus in accordance with the invention;

FIG. 11 shows a sectional representation in a side view of the spherical embodiment of FIG. 10; and

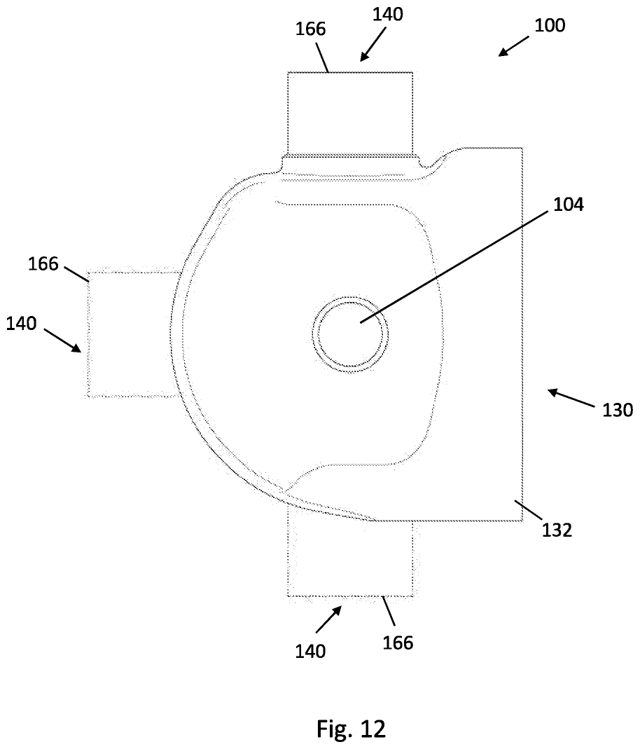

FIG. 12 shows a plan view of the spherical embodiment of FIG. 10 with alternative outlet pipe arrangements.

A schematic representation of an apparatus 100 for mixing an additive with a gas flow, for example an exhaust gas flow, is shown in FIG. 1A. It can be integrated into an exhaust gas purification device or connected upstream of such a device by which exhaust gases of an internal combustion engine are purified by means of an SCR process, among other things.

The apparatus 100 comprises a mixing chamber 102 and a metering device 104. The mixing chamber 102 can be flowed through by at least a portion of a gas flow at least has an inlet opening 108, a metering opening 112, and an outlet opening 114 (not shown in FIG. 1A, see, for example, FIG. 3). A main inlet flow 106 of the gas flow flows into the mixing chamber 102 through the inlet opening 108 on operation of the apparatus 100. An additive flow 110 of an additive is introduced into the mixing chamber 102 through the metering opening 112 by means of the metering device 104 on operation of the apparatus 100. The metering device 104 can be attached to the chamber 102.

The inlet opening 108 and the metering opening 112 are arranged and formed such that the main inlet flow 106 and the additive flow 110 flow in substantially opposite directions into the mixing chamber 102 so that the main inlet flow 106 and the additive flow 110 impact one another in the mixing chamber 102. In this connection, the term “substantially” is to be understood such that the directions of flow of the main inlet flow 106 and the additive flow 110 indeed have opposite directions (impact flow), but do not have to be aligned strictly in parallel with or coaxially to one another, which would correspond to an angle of 180° between the flows. A deviation of the center axis B of the additive flow 110 from the center axis A of the main inlet flow 106 can amount to between +45° and −45° (corresponding to an angle between the center axes A, B of 215° or 135°), in particular between +20° and −20°, preferably between +10° and −10°, and particularly preferably between +5° and −5°. Due to the opposite directions of flow of the main inlet flow 106 and the additive flow 110, the two flows impact one another in the mixing chamber 102. By controlling/regulating the metering device 104, the flow 110 can be adapted to the flow 106 to ensure their impacting in a suitable region in the interior of the chamber 102.

The mixing chamber 102 has a first side 116 and a second side 120 that are disposed opposite one another. The first side 116 comprises a first wall section 118 at which the inlet opening 108 of the mixing chamber 102 is arranged. The second side 120 comprises a second wall section 122 at which the metering opening 112 of the mixing chamber 102 is arranged. Curved sections can in particular also be provided at marginal regions of the first wall section 118 or the second wall section 122. The mixing chamber 102 furthermore has at least one lateral wall section 124 that connects the first wall section 118 and the second wall section 122 and that is arranged between the first side 116 and the second side 120 of the mixing chamber 102. The first wall section 118, the second wall section 122, and/or the lateral wall section 124 can be planar or curved, wherein curved wall sections 118, 122, 124 can assist a swirl formation of the gas flows in the interior of the mixing chamber 102. A lateral wall section 124 has in particular proved to be advantageous that has a kidney-shaped design in a cross-section in a plane that includes the center axis A of the main inlet flow 106 and/or the center axis B of the additive flow 110. A cross-section of the mixing chamber 102 perpendicular to the center axis A of the main inlet flow 106 and/or to the center axis B of the additive flow 110 can be rectangular or circular. However, the mixing chamber 102 can also have alternative geometries or cross-sections, such as oval or polygonal.

The metering device 104 is arranged at the second side 120 of the mixing chamber 102 and is configured to introduce an additive through the metering opening 112 into the mixing chamber 102 via an injection device, for example, via a nozzle. The additive can be injected into the mixing chamber 102 by the injection device, for example, in the form of a spray cone 126.

The main inlet flow 106 flows substantially symmetrically to the center axis A through the inlet opening 108 into the mixing chamber 102. The center axis A of the main inlet flow 106 extends approximately centrally through the inlet opening 108. The main inlet flow 106 flows toward the metering opening 112 in this respect. The additive flow 110 flows substantially symmetrically to the center axis B through the metering opening 112 into the mixing chamber 102. The center axis B of the additive flow 110 extends approximately centrally through the metering opening 112. The additive flow 110 flows toward the inlet opening 108 in this respect. The center axis A of the main inlet flow 106 and the center axis B of the additive flow 110 are coaxially arranged in the present example. In a rectangular design of the inlet opening 108, the center axis B of the additive flow 110 can lie in a center plane of the main inlet flow 106. The center plane of the main inlet flow 106 then comprises the center axis A of the main inlet flow 106 and is arranged substantially in parallel with the at least one lateral wall section 124 of the mixing chamber 102.

Due to the impacting of the main inlet flow 106 and the additive flow 110, the gaseous main inlet flow 106 and the liquid additive flow 110 mix in the mixing chamber 102. Furthermore, the direct impacting of the main inlet flow 106 with the additive flow 110 leads to a splitting, a spreading, or a division of the additive flow 110 so that the additive flow 110 is distributed in the interior of the mixing chamber 102.

The arrangement and the design of the inlet opening 108 and the metering opening 112 and the associated introduction of the additive flow 110 and the main inlet flow 106 in opposite directions into the mixing chamber 102 effects a good mixing with the additive flow 110 even with a small flow of the main inlet flow 106, for example with a small load of the internal combustion engine. A “spraying” of the additive through the mixing chamber 102, for example, with no or only little contact of the additive with the main inlet flow 106, can be largely avoided.

The flow conditions in the interior of the mixing chamber 102 depend on the properties of the mass flows 110, 106 and are load-dependent due to the usually much larger mass flow 106.

FIG. 1B shows a schematic representation of a further embodiment of the apparatus 100 in accordance with the invention in which an optional gaseous backflow 128 is additionally shown. The backflow 128, together with the additional flow 110 (droplet flow), can be introduced into the mixing chamber 102 through the metering opening 112. The backflow 128 assists the introduction of the additive flow 110 into the mixing chamber since the backflow 128 is mixed with the additive flow 110 and a gas-additive mixture produced in this manner flows into the mixing chamber 102 through the metering opening 112. In the interior of the mixing chamber 102, the main inlet flow 106 and the backflow 128 impact one another at an (idealized) stagnation point 129. Due to the impacting, the main inlet flow 106 and the gas-additive mixture are deflected such that the direction of flow of the main inlet flow 106 and the direction of flow of the backflow 128 extend substantially perpendicular to the center axis A of the main inlet flow 106 or to the center axis B of the additive flow 110 after the impact at the stagnation point 129. In other words, after their impact, the flows 106, 128 are deflected radially outwardly with respect to the center axes A, B and flow toward the lateral wall section 124. Due to the impact, the main inlet flow 106, the additive flow 110, and the backflow 128 mix and both an evaporation of the additive in the mixing chamber 102 and a mixing of the mentioned material flows take place. Due to the outward deflection of the direction of flow in the direction of the lateral wall section 124, the dwell time of the additive in the mixing chamber 102 can furthermore be increased, which in turn leads to a better evaporation of the additive. On an impacting of the deflected gas flows 106, 110, 128 on the lateral wall section 124, an evaporation of previously non-evaporated additive droplets occurs there. After the impacting of the gas flows 106, 110, 128 on the lateral wall section 124, the gas flows 106, 110, 128 are deflected again and are directed upwardly or downwardly along the lateral wall section 124 (cf. FIGS. 4A to 4C). This results in a swirling or in a swirl formation of the gas flows 106, 110, 128, which advantageously assists a further mixing and evaporation.

The location of the stagnation point 129 depends substantially on the properties of the mass flows of the main inlet flow 106 and the backflow 128 since the mass flow of the liquid additive flow 110 is usually much smaller than those of the gaseous mass flows 106, 128. If fixed geometric conditions are present, the stagnation point 129 does not shift or only shifts slightly, even under different load states of the internal combustion engine.

FIG. 2 shows a perspective representation of an inlet side 130 of an embodiment of the apparatus 100 in accordance with the invention. The mixing chamber 102 is at least sectionally surrounded by a cylindrical housing 132, wherein the housing 132 has a gas inlet at the inlet side 130. The gas inlet corresponds to the entire cross-section of the housing 132.

A gas-conducting component 134 is arranged at the inlet side 130 and is configured as a circular plate having selectively distributed openings 136 through which the gas flow can flow into a gap 138 between the housing 132 and the mixing chamber 102 (see FIG. 4).

The openings 136 of the gas-conducting component 134 are arranged in a radial marginal region. A central region of the gas-conducting component 134 forms a part of the wall section 124. In a region adjacent to the inlet opening 108 of the mixing chamber 102, no opening 136 is provided in the gas-conducting component 134. It is thereby prevented that at least a portion of the gas flow flows into the opening 108 without a substantial deflection so that it cannot flow directly into the mixing chamber 102. The openings 136 are designed such that the gas flow flowing into the gap 138 through the openings 136 is deflected and divided, namely into a comparatively small part flow that flows to the metering device 104, into a slightly larger part flow that passes to the metering opening 112, and into a comparatively large part flow that flows toward the inlet opening 108. Due to its inflow, the gas flow furthermore heats the gas-conducting component 134 and thus the lateral wall section 124 of the mixing chamber 102.

FIG. 3 shows a perspective representation of an outlet side 140 of the embodiment described in FIG. 2. An outlet opening 114 in an axial wall 144, which likewise forms a part of the wall section 124 of the mixing chamber 102, has a spectacle-shaped cross-section, for example in the form of an eight lying on its side, wherein the cross-section of the outlet opening 114 is smaller than the cross-section of the mixing chamber 102. A gas flow flowing into the housing 132 and then into the mixing chamber 102 can only exit from the mixing chamber 102 via the outlet opening 114. Thus, the outlet opening 114 of the mixing chamber 102 forms a gas outlet of the apparatus 100. The housing 132 itself does not have a gas outlet.

FIG. 4A shows a sectional representation of the embodiment described in FIG. 2. The mixing chamber 102 is bounded by the first wall section 118, the second wall section 122, and the lateral wall section 124. In the described cylindrical embodiment of the apparatus 100, the mixing chamber 102 in each case has two first wall sections 118, two second wall sections 122, and two lateral wall sections 124 (formed by portions of the component 134 or of the wall 144). The first wall sections 118 of the mixing chamber 102, which are separated by the inlet opening 108, are each at least sectionally designed as concavely curved, in particular in the shape of a flat U. They thereby develop a funnel effect for the inlet opening 108.

The metering opening 112 is arranged and designed such that a portion of the gas flow in the housing 132 flows as a backflow 128 together with the additive flow 110 through the metering opening 112 into the mixing chamber 102. The metering device 104 is supported by the housing 132 and is arranged spaced apart from the inlet opening 108.

However, in other embodiments, the first wall sections 118 can also be curved in a different manner. The curvature of the first wall sections 118 can assist a swirl formation of the gas flows in the interior of the mixing chamber 102. The first wall sections 118 can in particular act as a kind of deflector that directs a stagnation flow, which is produced due to the flows 106, 110, 128 (incoming main inlet flow 106, incoming additive flow 110 flowing in the opposite direction to the main inlet flow 106, and backflow 128) meeting at the stagnation point 129, along the curved surface of the first wall sections 118 in the direction of the metering opening 112 again. The lateral wall sections 124 disposed between the inlet opening 108 and the metering opening 112 are likewise at least sectionally curved. The curvatures of the individual wall sections 118, 122, 124 are adapted to the conditions to be expected on operation of the apparatus 100 in order to produce a swirl structure or a vortex structure in the interior of the mixing chamber 102.

Between the housing 132 and the mixing chamber 102, the gap 138 is at least sectionally formed, said gap 138 being flowed through by at least a portion of the gas flow entering into the gap 138 through the gas inlet, in particular through the openings 136 of the gas-conducting component 134 (cf. FIG. 2), on operation of the apparatus 100. The gas-conducting component 134 therefore serves to influence the gas flow in the gap 138 and/or into the gap 138. Further components can be arranged in the gap 138, as required, to design the flow pattern.

A flow-conducting device 142 described in more detail below is arranged between the gap 138 and the metering opening 112. It influences the formation of the backflow 128. A collar 123 that is formed at the wall section 122 and that projects into the interior of the mixing chamber 102 facilitates the inflow of the backflow 128 into the chamber 102. The collar 123 also deflects gas flowing along the wall section 124 into the interior of the mixing chamber 102 again in order to assist the swirl formation or vortex formation.

The metering device 104 is protected from a direct inflow of gas by a flow-conducting unit 154, which will be explained in more detail below. A screening metal plate 145 having a collar 143 projecting toward the metering device 104 is furthermore provided. Lateral marginal sections 145A of the screening metal plate 145 prevent a lateral outflow of gas from the metering-in region into the gap 138, and vice versa (see FIG. 5).

The interior of the mixing chamber 102 is in communication with the interior of the housing 132 at least via the inlet opening 108. In the interior of the mixing chamber 102, the main inlet flow 106 and the additive flow 110 impact one another on operation of the apparatus 100, wherein the additive flow 110 flows together with the backflow 128 through the metering opening 112 into the mixing chamber 102 and the main inlet flow 106 flows through the inlet opening 108 into the mixing chamber 102. A resulting stagnation flow enables a large-area distribution of the gas-additive mixture within the mixing chamber 102. The bounding wall sections 118, 122, 124 of the mixing chamber 102, i.e. the first wall sections 118, the second wall sections 122 and the lateral wall sections 124, serve as evaporator metal sheets and are flowed around at an outer side by the exhaust gas flow flowing through the openings 136 into the gap 138 and are thus heated, whereby an improvement in the evaporation of the additive mixture is achieved in the interior of the mixing chamber 102.

The formation of the flow pattern of the flows 106, 110, 128 produced in the interior of the chamber 102 also depends—in addition to the geometric design of the components of the apparatus 100—on the operating state, i.e. on the properties of the gas flow (which in turn depends on the load state of the internal combustion engine) and on the metering-in characteristics of the additive. This will be explained with reference to the following Figures.

FIG. 4B shows, in addition to FIG. 4A, a schematic representation of the distribution of the additive flow 110 in the mixing chamber 102 at a relatively high inflow speed of the main inlet flow 106. When the main inlet flow 106 flows into the mixing chamber 102 at a relatively high speed, the additive flow 110 is deflected together with the backflow 128 in the direction of an impact surface 152, wherein the impact surface is arranged at an upper wall section 124, in the vicinity of the metering opening 112.

In contrast to FIG. 4B, FIG. 4C shows a schematic representation of the distribution of the additive flow 110 in the mixing chamber 102 at a relatively low inflow speed of the main inlet flow 106. When the main inlet flow 106 flows into the mixing chamber 102 at a relatively low speed, the additive flow 110 is deflected together with the backflow 128 in the direction of an impact surface 152, wherein the impact surface is arranged at a lower wall section 124, in the vicinity of the inlet opening 108.

The location of the stagnation point 129 remains substantially constant and is independent of the inflow speed of the main inlet flow 106 since the main inlet flow 106 and the backflow 128 are—as explained—substantially dependent on the geometric conditions (e.g. on the ratio of the size and/or on the design of the openings for the main inlet flow 106 and the backflow 128) and are therefore in a fixed relationship to one another. Regardless of the inflow speed of the main inlet flow 106, the stagnation flow that is being formed in the interior of the mixing chamber 102 results in an efficient evaporation of the additive flow 110 since the stagnation flow deflects the additive flow 110 radially outwardly onto the evaporator surfaces and the geometric design of the evaporator surfaces results in a swirl formation of the stagnation flow in the interior of the mixing chamber 102, and the dwell time of the additive flow 110 in the mixing chamber 102 is thus extended.

FIG. 5 shows a perspective representation of the embodiment of FIG. 2 without a housing 132. The gas flow flowing in at the inlet side 130 of the apparatus 100 through the openings 136 of the gas-conducting component 134 is split into the main inlet flow 106 and the backflow 128, among others. The main inlet flow 106 flows into the mixing chamber 102 through the inlet opening 108. The backflow 128 flows into the mixing chamber 102 through the metering opening 112 that is preceded by the flow-conducting device 142. In the present example, the flow-conducting device 142 is a regionally perforated (separate) sheet metal part. The design of the perforation bounds the backflow 128.

The two oppositely introduced flows 106, 128 impact one another in the mixing chamber 102 and form the stagnation flow that has already been described multiple times and that leads to the formation of a complex swirl structure or vortex structure in cooperation with the geometric design of the mixing chamber 102.

FIG. 6 shows a sectional representation of the embodiment of FIG. 2 in a plane that is perpendicular to the center axis B of the additive flow 110, wherein a view from the interior of the mixing chamber 102 in the direction of the metering device 104 is shown. The mixing chamber 102 is bounded in the longitudinal direction, i.e. perpendicular to the flow axis C of the gas flow, by the gas-conducting component 134 at the inlet side 130 and by the axial wall 144 at the outlet side 140. Said gas-conducting component and said axial wall are inserted into the cylindrical housing 132. The wall sections 118, 122, 124 forming the chamber 102 are arranged between the plate-like components 134, 144. Said wall sections are formed at two substantially identical curved sheet metal parts (one to the right of axis C, one to the left thereof) that are spaced apart from one another so that the first wall sections 118 and the second wall sections 122 form the rectangular openings 108 or 112 (see also FIG. 7).

FIG. 7 shows a further sectional representation of the embodiment of FIG. 2 in a plane that is perpendicular to the center axis A of the main inlet flow 106, wherein a view from the interior of the mixing chamber 102 in the direction of the inlet opening 108 is shown. As already mentioned above, the inlet opening 108 formed by the first wall section 118 is designed as substantially rectangular in this embodiment. The inlet opening 108 is formed smaller than the metering opening 112 in the present case. Thus, at a constant exhaust gas counter-pressure, a higher inflow speed of the main inlet flow 106 can be achieved compared to an inflow speed of the backflow 128.

FIG. 8 shows a sectional representation of the embodiment of FIG. 2 in a plane that includes the center axis B. The gas flow flowing into the housing 132 through the openings 136 of the gas-conducting components 134 enters the mixing chamber 102 through the metering opening 112 after passing through the flow-conducting device 142. The flow-conducting device 142 serves to influence the backflow 128 prior to entering the metering opening 112. It also acts as a screen of the spray cone 126. A further function of the flow-conducting device 142 can be an additional swirl generation in the backflow 128. A backflow 128 impacted by swirl can contribute towards a stabilization of the spray cone 126. Unlike shown, planar and/or curved guide surfaces can be provided that effect such a swirl formation. If required, a (partial) mixing of the backflow 128 with the additive flow 110 can also be provided in the mixing chamber 102.

It can also be seen in FIG. 8 that the flow-conducting unit 154 has a collar 143A that projects into the collar 143 of the screening metal plate 145.

FIG. 9 shows a representation of the apparatus 100 of FIG. 2 in a section through the flow-conducting unit 154 with swirl generation (preferably a separate sheet metal part) in a plane perpendicular to the center axis B. In this embodiment, the flow-conducting unit 154 is designed as circular and has flow-conducting surfaces 162 that are arranged distributed in a peripheral direction and that are each associated with a flushing opening 158. The flow-conducting surfaces 162 are sections that are bent from a jacket surface of the flow-conducting unit 154 and that extend into the interior of the flow-conducting unit 154. A gas flow that flows at the inlet side 130, in particular through the openings 136 of the gas-conducting component 134, into the housing 132 is partly conducted in the direction of the metering device 104 through one of the openings 136. This gas portion then flows as a flushing flow through the flow-conducting unit 154 to the metering device 104. In this respect, the flushing flow is set into a swirling movement or a rotational movement about the center axis B of the additive flow 110 by the flow-conducting surfaces 162 before the flushing flow impacts the additive flow 110. The flushing flow prevents the formation of deposits in the region of a nozzle of the metering device 104. Such flow-conducting surfaces 162 are not provided in the embodiment in accordance with FIG. 2, which can be easily recognized with reference to FIG. 5.

FIG. 10 shows a perspective representation of an inlet side 130 of a further embodiment of the apparatus 100 in accordance with the invention. FIG. 11 shows a section through the same.

The mixing chamber 102 has a toroidal basic shape and comprises a plurality of outlet openings 114 (see FIG. 11) that are in communication with a channel 146 that surrounds the mixing chamber 102 in a peripheral direction. Said channel is formed by an annular sheet metal shell that is fastened to the at least sectionally straight sidewall section 124 and that covers the outlet openings 114.

The channel 146 has an outlet 164 that is in turn connected to an outlet pipe 166. The gas flow that previously flowed completely through the mixing chamber 102 exits the apparatus 100 through the outlet pipe 166.

The mixing chamber 102 comprises a plurality of secondary openings 148 which are preferably distributed in a regular manner in a peripheral direction and through which a secondary inlet flow 156 of the gas flow flows into the mixing chamber 102 on operation of the apparatus 100. Each secondary opening 148 is associated with at least one flow-conducting section 150 that is designed and arranged such that the secondary inlet flow 156 is deflected when entering into the mixing chamber 102, in the example shown, into the curved wall sections 118. The secondary inlet flow 156 flowing into the mixing chamber 102 through the secondary openings 148 causes a back flushing of the main inlet flow 106, which can result in an acceleration of the main inlet flow 106. The at least one flow-conducting section 150 can in particular be designed as a planar and/or a curved wall section such that a perpendicular inflow of the secondary inlet flow 156, i.e. an inflow orthogonal to a wall section of the mixing chamber 102, into the mixing chamber 102 is prevented. The flow-conducting sections 150 can produce a gas flow with an additional swirl component and/or can amplify swirl components that are already present. Pressure losses in the mixing chamber 102 can furthermore be reduced by the secondary openings 148.

The metering device 104 is associated with a screening device 152 (e.g. a sheet metal part) that is preferably formed separately and that has a plurality of flushing openings 158 through which a portion of the gas flow passes as a flushing flow into an injection region of the metering device 104 and protects the latter from the formation of deposits. The screening device 152 comprises a collar 143B that projects in the direction of the mixing chamber 102.

A flow-conducting unit 154 (with or without swirl generation) is furthermore provided that is arranged between the screening device 152 and the mixing chamber 102.

The flow-conducting unit 154 with swirl generation can be formed as a separate cast component and comprises flow-conducting surfaces 162 that act as swirl flaps to generate a rotation of the backflow 128 flowing through the flow unit 154 about the center axis B of the additive flow 110. The backflow 128 rotating about the center axis B of the additive flow 110 impacts the collar 143B of the screening device 152, whereby the backflow 128 is deflected into the interior of the mixing chamber 102. The collar 143B simultaneously protects the spray cone 126 from an excessive dispersal.

FIG. 12 shows a plan view of the spherical embodiment of FIG. 10 with alternatively arranged outlet pipes 166 (shown by dashed lines). The spherical embodiment of the apparatus 100 offers the advantage that the outlet pipe 166 can be arranged at any desired outlet side 140 of the apparatus 100 depending on the installation position of the apparatus 100 in an exhaust gas system.

A common feature of the embodiments described is that an impact flow is generated in the respective device and mixes an introduced additive, for example a urea solution, with a gas flow (e.g. an exhaust gas flow). Optionally, a backflow 128 can be provided that is introduced into the mixing chamber 102 with the additive flow 110, whereby a stagnation flow is produced. In this respect, the material flows are urged radially outwardly so that the already partly mixed flows flow toward an evaporator surface that can be comparatively large. The impact flow and/or the stagnation flow can be embedded in a vortex structure that is produced by the design of the mixing chamber 102 and that improves a mixing of the (evaporated) additive with the gas flow. The functionality of the apparatus 100 is also given at comparatively small exhaust gas mass flows. A high droplet evaporation can also be achieved with a smaller exhaust gas flow and little dispersal of the drop-shaped additive. Accordingly, advantages of the apparatus 100 in accordance with the invention are an efficient evaporation of the additive and its reliable mixing with the gas flow over a large load range. Due to the apparatus 100 in accordance with the invention, advantages in terms of installation space furthermore result, for example, due to the possibility of designing said apparatus 100 in a modular manner and/or adapting it to the respective present conditions with only a small design effort.

The details explained by way of example with reference to the embodiments described above can be combined in a variety of ways to achieve the desired flow conditions.

### REFERENCE NUMERAL LIST

100 apparatus
102 mixing chamber
104 metering device
106 main inlet flow
108 inlet opening
110 additive flow
112 metering opening
114 outlet opening
116 first side of the mixing chamber
118 first wall section
120 second side of the mixing chamber
122 second wall section
123 collar
124 lateral wall section
126 spray cone
128 backflow
129 stagnation point
130 inlet side
132 housing
134 gas-conducting component
136 opening
138 gap
140 outlet side
142 flow-conducting device
143, 143A, 143B collar
144 axial wall
145 screening metal plate
145A marginal section
146 channel
148 secondary opening
150 flow-conducting section
152 screening device
154 flow-conducting unit
158 flushing opening
162 flow-conducting surface
164 outlet
166 outlet pipe
A center axis of the main inlet flow
B center axis of the additive flow
C flow axis of the gas flow

1. An apparatus for mixing an additive with a gas flow, said apparatus comprising
a mixing chamber which can be flowed through by at least a portion of the gas flow, said mixing chamber having at least one inlet opening through which a main inlet flow of the gas flow flows into the mixing chamber on operation of the apparatus, having at least one metering opening and having at least one outlet opening; and
a metering device by means of which an additive flow of the additive can be introduced into the mixing chamber through the metering opening, wherein the inlet opening and the metering opening are arranged and formed such that the main inlet flow and the additive flow flow in substantially opposite directions into the mixing chamber so that the main inlet flow and the additive flow impact one another.

2. The apparatus in accordance with claim 1,
wherein the inlet opening and the metering opening are arranged at mutually oppositely disposed wall sections of the mixing chamber.

3. The apparatus in accordance with claim 1,
wherein the inlet opening is designed as substantially round or rectangular.

4. The apparatus in accordance with claim 1,
wherein a center axis of the main inlet flow and a center axis of the additive flow are arranged substantially coaxially, or wherein a center axis of the additive flow lies in a center plane of the main inlet flow.

5. The apparatus in accordance with claim 4,
wherein the outlet opening of the mixing chamber is arranged at a wall section that, viewed in the direction of the center axis of the main inlet flow or of the additive flow, is disposed between the metering opening and the inlet opening.

6. The apparatus in accordance with claim 4,
wherein the outlet opening of the mixing chamber forms a gas outlet of the apparatus.

7. The apparatus in accordance with claim 1,
wherein the mixing chamber is circular or rectangular in a plane perpendicular to the center axis of the main inlet flow and of the additive flow.

8. The apparatus in accordance with claim 1,
wherein at least one wall section of the mixing chamber having the inlet opening is designed as at least sectionally curved.

9. The apparatus in accordance with claim 8,
wherein the at least one wall section adjacent to the inlet opening is designed in U shape.

10. The apparatus in accordance with claim 1,
wherein wall sections disposed between the inlet opening and the metering opening are at least sectionally curved.

11. The apparatus in accordance with claim 1,
wherein the mixing chamber has at least one secondary opening through which a secondary inlet flow of the gas flow flows into the mixing chamber on operation of the apparatus.

12. The apparatus in accordance with claim 11,
wherein the secondary opening is associated with at least one flow-conducting section that is designed and arranged such that the secondary inlet flow is deflected when entering into the mixing chamber.

13. The apparatus in accordance with claim 12,
wherein the least one flow-conducting section is a planar and/or a curved wall section.

14. The apparatus in accordance with claim 1,
wherein the metering device is associated with a screening device that has at least one flushing opening through which a portion of the gas flow passes as a flushing flow into an injection region of the metering device.

15. The apparatus in accordance with claim 14,
wherein the flushing opening is associated with a flow-conducting unit.

16. The apparatus in accordance with claim 1,
wherein the mixing chamber is at least sectionally surrounded by a housing that has a gas inlet for the gas flow, wherein the interior of the mixing chamber is in communication with the interior of the housing at least via the inlet opening.

17. The apparatus in accordance with claim 16,
wherein the outlet opening of the mixing chamber is in communication with a channel through which the gas flow exiting from the mixing chamber is discharged from the housing.

18. The apparatus in accordance with claim 17,
wherein the channel at least sectionally surrounds the mixing chamber at an outer side in a region between the metering opening and the inlet opening in a peripheral direction.

19. The apparatus in accordance with claim 18,
wherein the channel completely surrounds the mixing chamber.

20. The apparatus in accordance with claim 16,
wherein the metering device is supported by the housing and is arranged spaced apart from the inlet opening.

21. The apparatus in accordance with claim 16,
wherein a gap is at least sectionally formed between the mixing chamber and the housing and, during operation, is flowed through by at least a portion of the gas flow entering the housing through the gas inlet.

22. The apparatus in accordance with claim 21,
wherein at least one gas-conducting component is arranged in the gap or in the direction of flow upstream of the gap in order to influence the gas flow in the gap and/or into the gap.

23. The apparatus in accordance with claim 17,
wherein the metering opening is arranged and designed such that a portion of the gas flow in the housing flows as a backflow together with the additive flow through the metering opening into the mixing chamber.

24. The apparatus in accordance with claim 23,
wherein a flow-conducting device is provided that is configured to influence the backflow prior to the entry into the metering opening.

25. The apparatus in accordance with claim 24,
wherein the flow-conducting device comprises a separate component and/or wherein the flow-conducting device is formed by at least one component that—if provided—is formed at the screening device and/or at the mixing chamber.

26. The apparatus in accordance with claim 25,
wherein the at least one component is formed in the form of a collar formed at—if provided—the screening device and/or at the mixing chamber.

27. The apparatus in accordance with claim 14,
wherein the apparatus is designed such that, during operation, the main inlet flow portion of the gas flow is greater than the portion of the backflow and/or the portion of the backflow is greater than the portion of the flushing flow, wherein the main inlet flow makes up 70% to 30, and/or the backflow makes up 60% to 30, and/or the flushing flow makes up 20% to 1% of the gas flow.

28. The apparatus in accordance with claim 1,
wherein the apparatus further comprises at least one further metering device by means of which a further additive flow of the additive can be introduced into the mixing chamber through the metering opening of the mixing chamber or through a further metering opening of the mixing chamber, wherein the inlet opening and the metering opening or the further metering opening are arranged and formed such that the main inlet flow and at least one of the additive flows flow in substantially opposite directions into the mixing chamber so that the main inlet flow and the additive flow impact one another.

29. An exhaust gas system that comprises an apparatus for mixing an additive with a gas flow, said apparatus comprising
a mixing chamber which can be flowed through by at least a portion of the gas flow, said mixing chamber having at least one inlet opening through which a main inlet flow of the gas flow flows into the mixing chamber on operation of the apparatus, having at least one metering opening and having at least one outlet opening; and
a metering device by means of which an additive flow of the additive can be introduced into the mixing chamber through the metering opening, wherein the inlet opening and the metering opening are arranged and formed such that the main inlet flow and the additive flow flow in substantially opposite directions into the mixing chamber so that the main inlet flow and the additive flow impact one another.

30. A vehicle comprising an internal combustion engine that is connected to an exhaust gas system that comprises an apparatus for mixing an additive with a gas flow, said apparatus comprising
a mixing chamber which can be flowed through by at least a portion of the gas flow, said mixing chamber having at least one inlet opening through which a main inlet flow of the gas flow flows into the mixing chamber on operation of the apparatus, having at least one metering opening and having at least one outlet opening; and
a metering device by means of which an additive flow of the additive can be introduced into the mixing chamber through the metering opening, wherein the inlet opening and the metering opening are arranged and formed such that the main inlet flow and the additive flow flow in substantially opposite directions into the mixing chamber so that the main inlet flow and the additive flow impact one another.
